(19) United States
(12) Patent Application Publication
(10) Pub. No.: US 2026/0140875 A1
(43) Pub. Date: May 21, 2026

(54) MEMORY MANAGEMENT DEVICE AND METHOD USING A HASH-BASED DISTRIBUTED PAGE TABLE

(71) Applicant: RESEARCH & BUSINESS FOUNDATION SUNGKYUNKWAN UNIVERSITY, Suwon-si (KR)

(72) Inventors: Seok In HONG, Suwon-si (KR); Yong Ho Lee, Suwon-si (KR); O Sang Kwon, Suwon-si (KR); Sung Bin Jang, Suwon-si (KR); Jun Hyeok Park, Suwon-si (KR)

(21) Appl. No.: 19/381,501

(22) Filed: Nov. 6, 2025

(30) Foreign Application Priority Data
Nov. 20, 2024 (KR) 10-2024-0165863

(51) Int. Cl. G06F 12/02

(52) U.S. Cl. CPC G06F 12/0292; G06F 2212/1044

(57) ABSTRACT

The present invention relates to a memory management device and method using a hash-based distributed page table, according to an embodiment, the memory management method using a hash-based distributed page table may comprise generating a physical frame number (PFN) of a page table entry (PTE) by inputting a process ID (PID) and a virtual page number (VPN) included in a virtual address (VA) for a virtual memory into a hash function; generating an address of the page table entry including the physical frame number and an offset of the page table entry included in the virtual address; and generating a distributed page table (DPT) allocating a page table entry page for an entire memory area based on the generated page table entry address.

### CROSS-REFERENCE TO RELATED APPLICATION

This application claims the priority benefit of Korean Patent Application No. 10-2024-0165863 filed on Nov. 20, 2024, in the Korean Intellectual Property, the disclosures of which are incorporated herein by reference.

### BACKGROUND

### 1. Field

The present invention relates to a memory management device and a memory management method using a hash-based distributed page table.

### 2. Description of the Related Art

Virtual memory systems provide important abstraction functions in modern computer systems, which perform essential functions such as memory virtualization and process isolation. In such a virtual memory system, a key component is the page table, which performs the function of translating virtual addresses into physical addresses. The existing Radix Page Table (RPT) manages Page Table Entry (PTE) through a hierarchical tree structure, and performs address translation using a page table walk method sequentially accessing these PTE.

As an alternative to solving this problem, a hash page table (HPT) has been proposed. HPT is designed to quickly find the page table entry location by hashing the virtual page number, and is evaluated as an efficient structure compared to the existing RPT in that address conversion is possible with single memory access. However, HPT has several distinct problems. First, it is difficult to effectively manage hash collision, which may require table size adjustment and additional memory access, thereby causing performance degradation. Second, since the HPT requires continuous physical memory space for the entire table, it is difficult to secure sufficient continuous memory space as the table becomes larger. For this reason, HPT may be inefficient in memory management, and there is a limit to its application in a memory-intensive environment.

Previous studies have suggested several ways to overcome the limitations of HPT. For example, one study proposed Elastic Cuckoo Page Table (ECPT) to improve the HPT collision problem, but there is still a limited problem because it requires continuous memory space, and research to solve this problem is gradually starting.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Provided are a memory management device and a memory management method using a hash-based distributed page table that generates a distributed page table (DPT) for allocating a page table entry page to an entire area of actual physical memory.

According to an embodiment, a memory management method using a hash-based distributed page table may comprise generating a physical frame number (PFN) of a page table entry (PTE) by inputting a process ID (PID) and a virtual page number (VPN) included in a virtual address (VA) for a virtual memory into a hash function; generating an address of the page table entry including the physical frame number and an offset of the page table entry included in the virtual address; and generating a distributed page table (DPT) allocating a page table entry page for an entire memory area based on the generated page table entry address.

In addition, according to one embodiment, the generating of the distributed page table comprises allocating at least one of a page table entry allocation page and a page table entry access page.

In addition, according to one embodiment, the generating of the distributed page table comprises scanning a frame bitmap of the memory to determine whether a physical frame of the memory corresponding to the physical frame number is empty; and when it is determined that the physical frame is empty, allocating a page in the memory corresponding to the physical frame as a page table entry page.

In addition, according to one embodiment, the generating of the distributed page table comprises, when it is determined that the physical frame is not empty, determining a predetermined page stride that matches a size of a page in the memory corresponding to the physical frame; and when a page in the memory that has moved from the page corresponding to the physical frame according to the predetermined page stride is empty, allocating the moved page as a page table entry page.

In addition, according to one embodiment, the generating of the distributed page table comprises, selecting the predetermined page stride from among a plurality of predetermined page strides.

In addition, according to one embodiment, when the distributed page table is generated, the determining of the moved page is performed by using the following equation. PFN_{PTE}=Hash(VPN tag)+Stride×Step (wherein, PFN_{PTE} denotes “physical frame number for the moved page”, Hash( ) denotes “hash function”, VPN tag denotes “virtual page number”, Stride denotes “predetermined page stride”, and Step denotes “a step of the moved page for each predetermined page stride”)

In addition, according to one embodiment, the generating of the distributed page table comprises, when it is determined that the physical frame is not empty, setting a new virtual page number obtained by increasing the virtual page number; generating a new physical frame number corresponding to the new virtual page number; and when a new page in the memory corresponding to the new physical frame number is empty, allocating the new page as a page table entry page.

In addition, according to one embodiment, the generating of the distributed page table comprises, when it is determined that the physical frame is not empty, moving a data page allocated to the physical frame to an empty page within the memory; and allocating a page in the memory corresponding to the physical frame as a page table entry page.

In addition, according to one embodiment, the generating of the distributed page table comprises, when moving a data page allocated to the physical frame to an empty page within the memory, setting the data page as a victim and moving the data page to the empty page within the memory.

In addition, according to one embodiment, the generating of the distributed page table comprises scanning a frame bitmap of the memory to determine whether a physical frame of the memory corresponding to the physical frame number is included in a fragmented region, and allocating a page in the memory corresponding to the physical frame as a page table entry page.

According to an embodiment, a memory management device using a hash-based distributed page table may comprise a memory having a physical memory space; and a processor configured to generate a physical frame number (PFN) of a page table entry (PTE) by inputting a process ID (PID) and a virtual page number (VPN) included in a virtual address (VA) for a virtual memory into a hash function, generate an address of the page table entry including the physical frame number and an offset of the page table entry included in the virtual address and generate a distributed page table (DPT) allocating a page table entry page for an entire memory area based on the generated page table entry address.

In addition, according to one embodiment, the processor is configured to allocate at least one of a page table entry allocation page and a page table entry access page.

In addition, according to one embodiment, the processor is configured to scan a frame bitmap of the memory to determine whether a physical frame of the memory corresponding to the physical frame number is empty and, when it is determined that the physical frame is empty, allocate a page in the memory corresponding to the physical frame as a page table entry page.

In addition, according to one embodiment, the processor is configured to, when it is determined that the physical frame is not empty, determine a predetermined page stride that matches a size of a page in the memory corresponding to the physical frame and, when a page in the memory that has moved from the page corresponding to the physical frame according to the predetermined page stride is empty, allocate the moved page as a page table entry page.

In addition, according to one embodiment, the processor is configured to select the predetermined page stride from among a plurality of predetermined page strides.

In addition, according to one embodiment, when the processor generates the distributed page table, determining the moved page is determined through the following equation.

$${PFN}_{PTE} = Hash ( VPN tag ) + Stride \times Step$$

(wherein, PFN_{PTE} denotes “physical frame number for the moved page”, Hash( ) denotes “hash function”, VPN tag denotes “virtual page number”, Stride denotes “predetermined page stride”, and Step denotes “a step of the moved page for each predetermined page stride”)

In addition, according to one embodiment, the processor is configured to, when it is determined that the physical frame is not empty, set a new virtual page number obtained by increasing the virtual page number, generate a new physical frame number corresponding to the new virtual page number and, when a new page in the memory corresponding to the new physical frame number is empty, allocate the new page as a page table entry page.

In addition, according to one embodiment, the processor is configured to, when it is determined that the physical frame is not empty, move a data page allocated to the physical frame to an empty page within the memory and allocate a page in the memory corresponding to the physical frame as a page table entry page.

In addition, according to one embodiment, the processor is configured to, when moving a data page allocated to the physical frame to an empty page within the memory, set the data page as a victim and move the data page to the empty page within the memory.

In addition, according to one embodiment, the processor is configured to scan a frame bitmap of the memory to determine whether a physical frame of the memory corresponding to the physical frame number is included in a fragmented region, and allocate a page in the memory corresponding to the physical frame as a page table entry page.

According to the memory management device and method using the hash-based distributed page table described above, a distributed page table (DPT) for allocating a page table entry page to the entire area of the actual physical memory may be generated.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a terminal to which a memory management device using a hash-based distributed page table DPT according to an embodiment may be applied.

FIG. 2 is a block diagram of the memory management device using the hash-based distributed page table DPT according to an embodiment.

FIG. 3 is a detailed block diagram of the memory management device using the hash-based distributed page table DPT according to an embodiment.

FIG. 4 is a detailed block diagram of the memory management device using the hash-based distributed page table DPT according to an embodiment.

FIG. 5 is a conceptual diagram illustrating that the address generation module of the memory management device using the hash-based distributed page table DPT generates a page table entry address according to an embodiment.

FIGS. 6, 7, and 8 are conceptual diagrams illustrating that the allocation module of the memory management device using the hash-based distributed page table DPT according to an embodiment allocates a page table entry address to generate a distributed page table DPT.

FIGS. 9, 10, 11, and 12 are conceptual diagrams illustrating that the SOA module of the memory management device using the hash-based distributed page table DPT generates the distributed page table DPT through the SOA technique.

FIGS. 13, 14, 15, and 16 are conceptual diagrams illustrating that the CVA module of the memory management device using the hash-based distributed page table DPT generates the distributed page table DPT through the CVA technique according to an embodiment.

FIGS. 17, 18, 19, 20, and 21 are conceptual diagrams illustrating that the CPD module 293 of the memory management device 100 using the hash-based distributed page table DPT generates the distributed page table DPT through the CPD technique.

FIGS. 22, 23, 24 and 25 are conceptual diagrams illustrating that the FAP module 294 of the memory management device 100 using the hash-based distributed page table DPT generates the distributed page table DPT through the FAP technique.

FIG. 26 is a flowchart of a memory management method using a hash-based distributed page table (DPT) according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, and methods for achieving them, will become apparent from the following description of exemplary embodiments with reference to the accompanying drawings. However, the present invention is not limited to the embodiments disclosed herein and may be implemented in various different forms. The embodiments are merely provided to ensure a complete disclosure of the present invention and to fully convey the scope of the invention to those skilled in the art to which the invention pertains. The scope of the present invention is defined only by the claims.

A brief explanation of the terms used in this specification will be provided below, followed by a detailed description of the present invention.

The terms used in the present invention have been selected from generally accepted terms that are widely used at present, taking into consideration the functions of the invention. However, such terms may vary depending on the intent of a person skilled in the art, judicial precedents, or the emergence of new technologies. In certain cases, terms arbitrarily chosen by the applicant may be used, in which case the meanings thereof will be described in detail in the corresponding portions of the specification. Accordingly, the terms used in the present invention should not be interpreted merely based on their names, but should be defined based on their meanings and the overall context of the present invention.

Throughout this specification, when a part or element is described as “including” another component, it means that the component may further include other elements unless otherwise expressly stated to the contrary, and does not exclude the presence of additional elements. In addition, the terms “part,” “module,” “unit,” and the like, as used herein, refer to units that process at least one function or operation, and may be implemented as hardware components such as software, FPGA, or ASIC, or as a combination of software and hardware. However, the terms “part,” “module,” and “unit” are not limited to software or hardware implementations. The “part,” “module,” or “unit” may be implemented to reside on an addressable storage medium and to reproduce one or more processors. Accordingly, by way of example, the terms “part,” “module,” and “unit” encompass components such as software components, object-oriented software components, class components, and task components, as well as processes, functions, attributes, procedures, subroutines, segments of program code, drivers, firmware, microcode, circuits, data, databases, data structures, tables, arrays, and variables.

The embodiments of the present invention will now be described in detail below with reference to the accompanying drawings so that those skilled in the art to which the invention pertains can readily implement the invention. In the drawings, parts irrelevant to the description are omitted for clarity of explanation.

Terms including ordinal numbers such as “first,” “second,” and the like may be used to describe various components, but such components are not limited by these terms. The terms are merely used to distinguish one component from another. For example, a first component may be referred to as a second component without departing from the scope of the present invention, and similarly, a second component may be referred to as a first component. The term “and/or” includes any combination of a plurality of associated items or any one of the plurality of associated items.

Hereinafter, an embodiment of the memory management device 100 and the memory management method using the hash-based distributed page table DPT will be described with reference to the accompanying drawings.

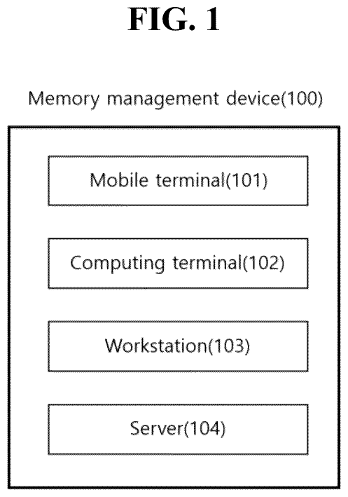

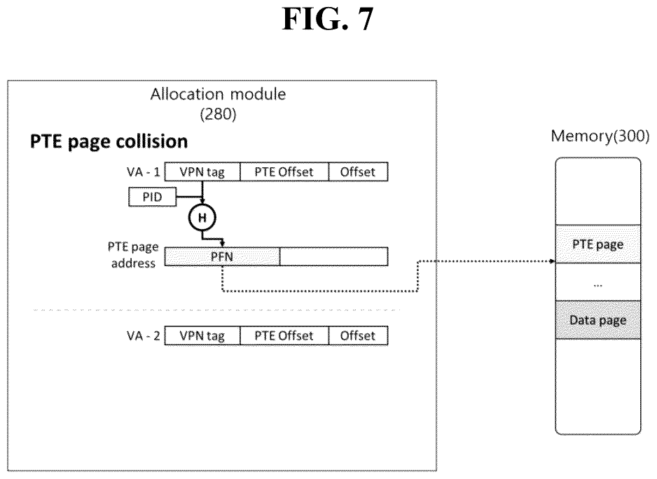

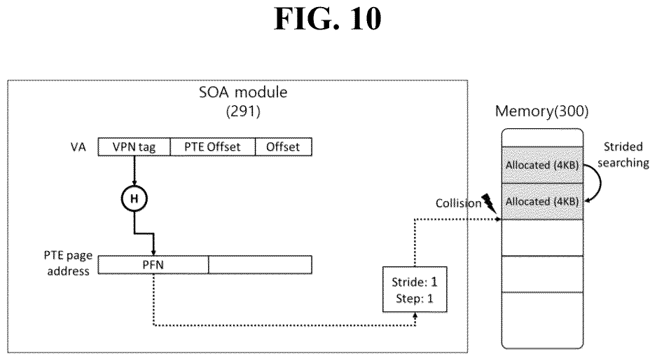

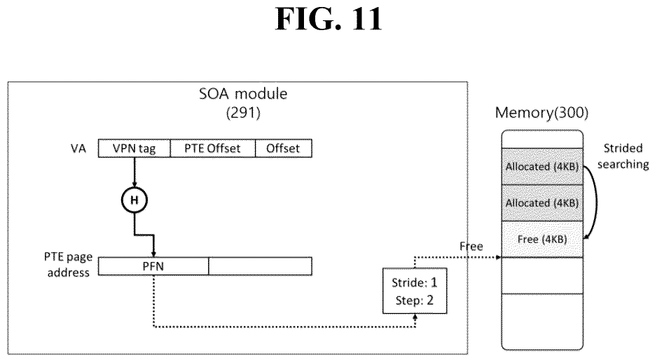

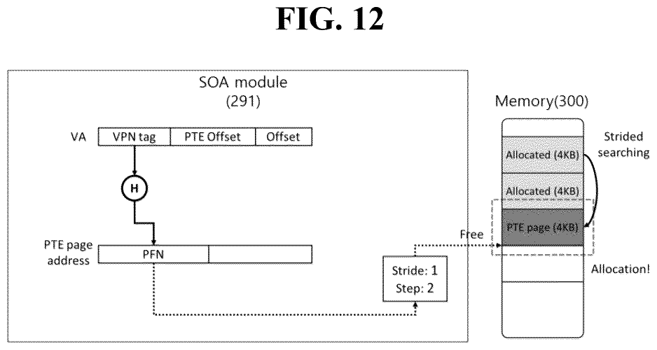

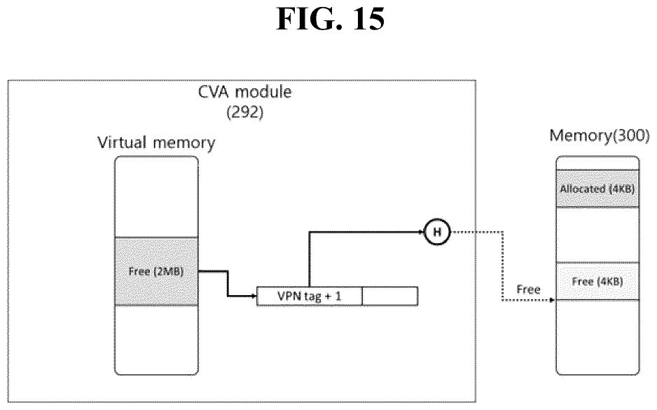

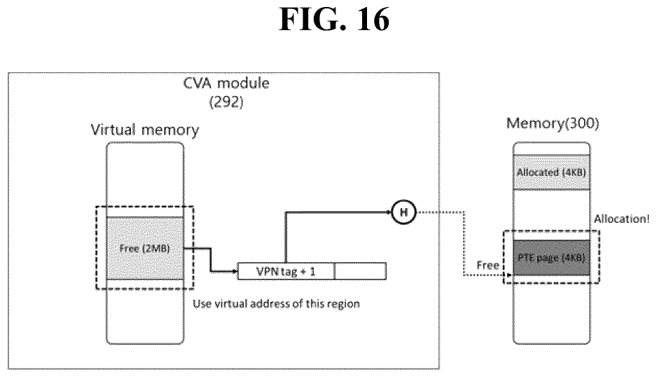

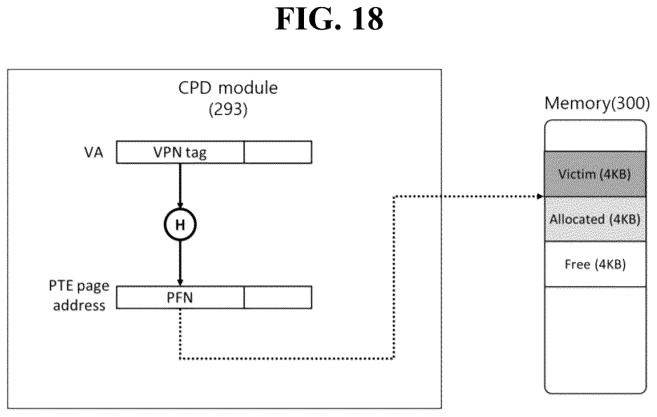

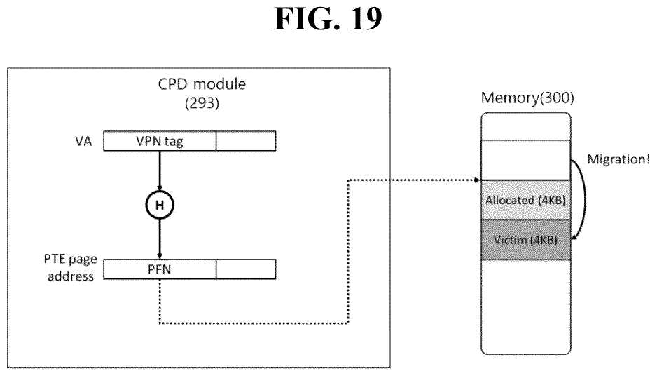

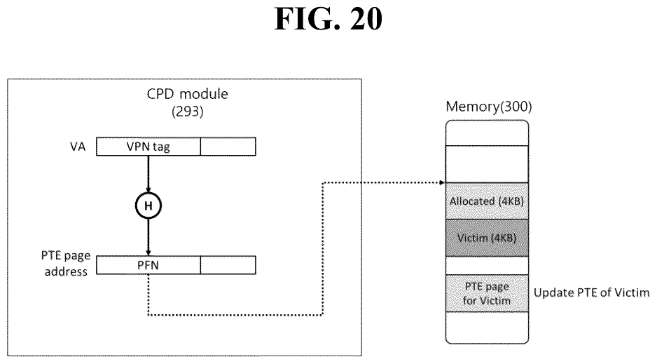

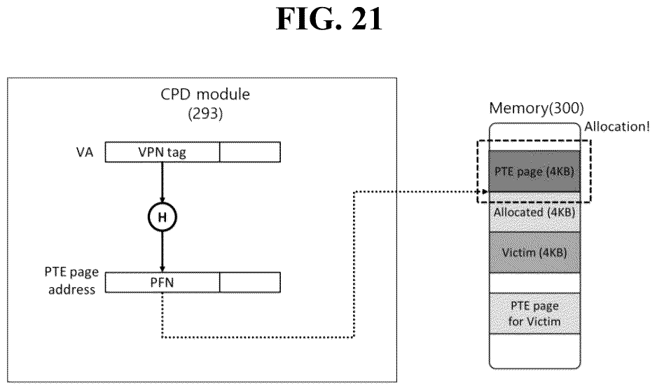

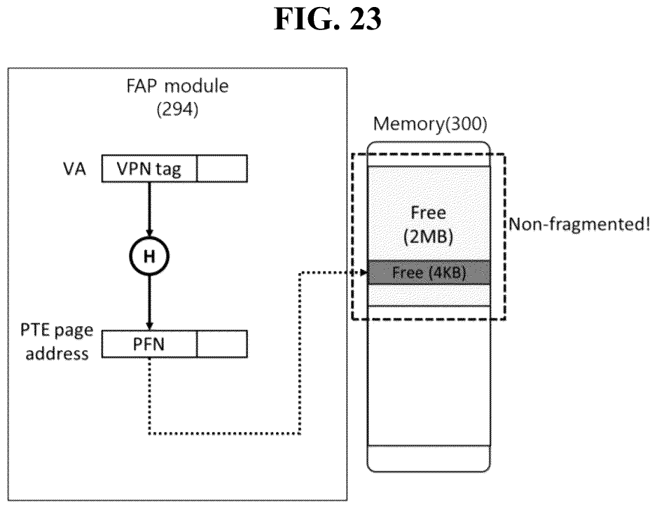

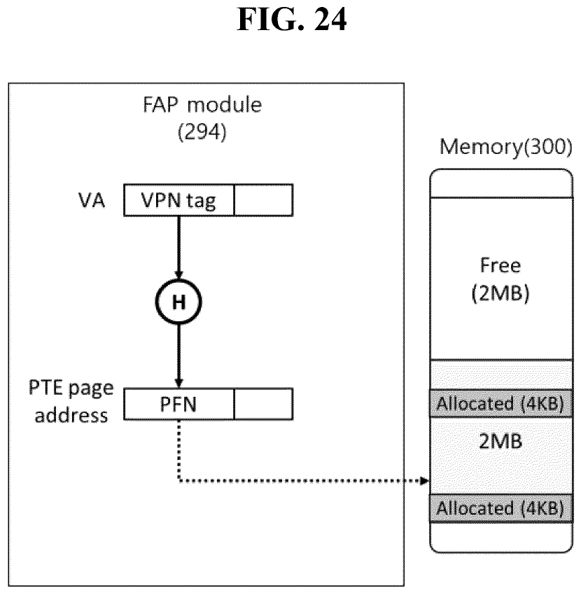

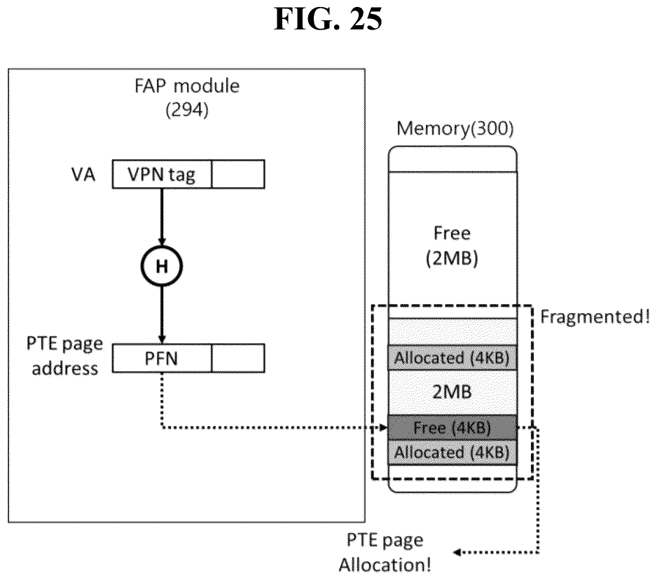

Hereinafter, an embodiment of the memory management device 100 using the hash-based distributed page table DPT will be described with reference to FIGS. 1 to 25.

FIG. 1 is a block diagram of a terminal to which a memory management device 100 using a hash-based distributed page table DPT according to an embodiment may be applied.

The memory management device 100 may manage the memory 300 by generating a virtual memory of the processor 200 and connecting it through generation of an address between the memory 300 and the virtual memory. The memory management device 100 may be applied to a mobile terminal 101, a computing terminal 102, a workstation 103, and a server 104, and may be applied to all devices to which an OS capable of executing a virtual memory is applied.

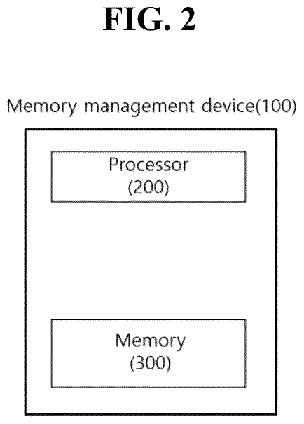

Hereinafter, a configuration including the memory management device 100 using the DPT will be described with reference to FIGS. 2 to 4.

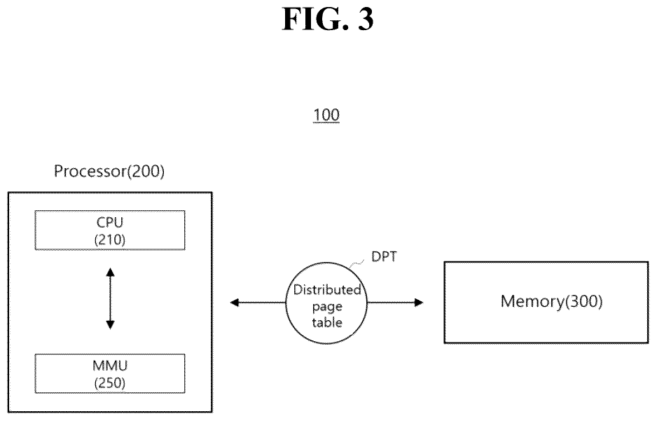

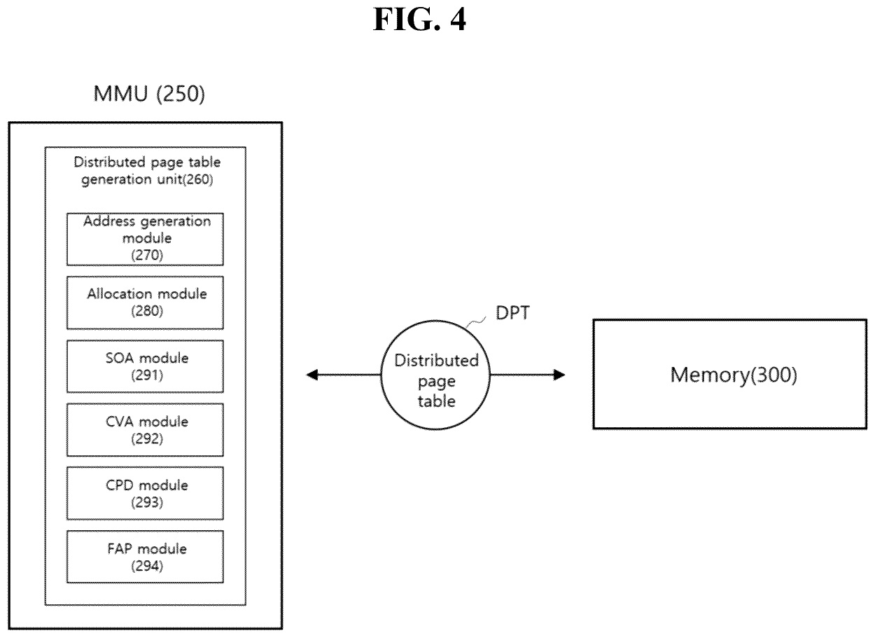

FIG. 2 is a block diagram of the memory management device 100 using the hash-based distributed page table DPT according to an embodiment, FIG. 3 is a detailed block diagram of the memory management device 100 using the hash-based distributed page table DPT according to an embodiment, and FIG. 4 is a detailed block diagram of the memory management device 100 using the hash-based distributed page table DPT according to an embodiment.

The memory management device 100 may include a processor 200 and a memory 300.

The processor 200 may generate a virtual memory in the processor 200 and connect it to the memory 300 through address setting to execute an operation between the physical memory 300 and the virtual memory. The processor 200 may include a CPU 210 and an MMU 220.

The processor 200 may include, for example, a Central Processing Unit (CPU), a Graphic Processing Unit (GPU), a Micro Controller Unit (MCU), an Application Processor (AP), an Electronic Controlling Unit (ECU), and/or at least one electronic device capable of performing various operations and control processing. These devices may be implemented, for example, by using one or two or more semiconductor chips, circuits, or related components alone or in combination.

The CPU 210 may execute a OS capable of executing the virtual memory to assist the operation processing, and may support an operation for executing the virtual memory in the MMU 220.

The memory management unit (MMU) 220 may execute a virtual memory to generate a virtual address to support connection with the physical memory 300. Specifically, the MMU 220 may input the process ID PID and the virtual page number VPN included in the virtual address VA into the hash function to generate the physical frame number PFN of the page table entries PTE, generate the address of the page table entry including the physical frame number and the offset of the page table entry included in the virtual address, and generate the distributed page table DPT for allocating the page table entry page to the entire area of the memory 300 based on the generated page table entry address. The MMU 220 may include a distributed page table generation unit 260, a translation lookaside buffer TLB, and a page walk cache PWC.

The distributed page table generation unit 260 may generate the distributed page table DPT by setting a PTE for the entire area of the memory 300. Specifically, the distributed page table generation unit 260 generates a distributed page table DPT, which is a new page table structure capable of overcoming fundamental limitations of the existing Hashed Page Table HPT design. The DPT may be generated by distributing the page table entry PTE in the entire memory 300 space. That is, the distributed page table generation unit 260 generates a DPT instead of allocating a small continuous memory 300 space to store the page table, and uses the entire physical memory 300 space as a huge HPT. The existing HPT uses a hash value as a table index, but in DPT, the hash value is used as an address of the physical memory 300 of the PTE to reduce the need for space allocation of the continuous memory 300. This approach of the distributed page table generation unit 260 eliminates the need to allocate space for the continuous memory 300.

The distributed page table generation unit 260 may include an address generation module 270, an allocation module 280, an SOA module 291, a CVA module 292, a CPD module 293, and a FAP module 294.

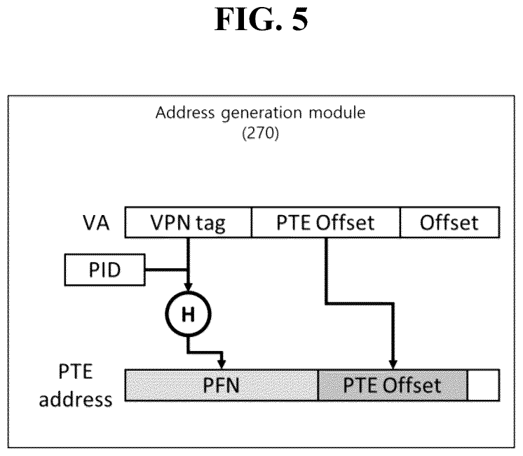

A detailed configuration of the address generation module 270, the allocation module 280, the SOA module 291, the CVA module 292, the CPD module 293, and the FAP module 294, and an embodiment of a memory management method will be described later with reference to FIGS. 5 to 25.

The memory 300 is a physical memory that is connected to the virtual memory and address of the processor 200, that is, to a distributed page table (DPT) including page table entries. The memory 300 may include a page having a plurality of allocated capacity size types.

The memory 300 may include at least one of a main memory device and an auxiliary memory device. For example, the main memory device may be implemented using a semiconductor storage medium such as a ROM and/or a RAM, and the auxiliary memory device may be implemented based on a device capable of permanently or semi-permanently storing data, such as a flash memory device (a SSD (Solid State Drive)), a Secure Digital (SD) card, a HDD (Hard Disc Drive), a compact disk, a DVD, or a laser disk.

FIG. 5 is a conceptual diagram illustrating that the address generation module 270 of the memory management device 100 using the hash-based distributed page table DPT generates a page table entry address according to an embodiment.

The address generation module 270 may generate the physical frame number PFN of the page table entry PTE by inputting the process ID PID and the virtual page number VPN included in the virtual address VA for the virtual memory into a hash function, and may generate an address of the page table entry including the physical frame number and an offset of the page table entry included in the virtual address.

Specifically, in the existing HPT, the table index for the virtual address VA is determined by using the virtual page number VPN as a hash key. However, this does not take into account the referential locality of PTE. To solve this problem, the address generation module 270 may divide the virtual address into three fields of a virtual page number tag (33 bits), an PTE offset (3 bits), and a page offset (12 bits), and store eight consecutive virtual pages of PTE in the cache line to increase the locality of the PTE.

The address generation module 270 uses a method of clustering consecutive PTE in the address conversion process to DPT. However, unlike the conventional PTE clustering, the address generation module 270 clusters 512 PTE with respect to the 2 MB virtual memory area with DPT and stores them in a 4 KB page. The address generation module 270 stores 512 PTE in the PTE page, similar to a general RPT, which may serve as a leaf node of the Radix tree, to which the address generation module 270 generates the DPT using 9 bits of the virtual address as the PTE offset.

FIG. 5 illustrates a method in which the address generation module 270 generates a physical PTE address for a given virtual address VA. The address generation module 270 calculates the physical frame number PFN of the PTE page using a hash function as an input of the VPN tag and the process ID PID. The PID may be used as a unique seed of the hash function because the VPN is not unique per process. A 9-bit PTE offset may be added to the PFN to specify the location of the PTE within the 4 KB PTE page.

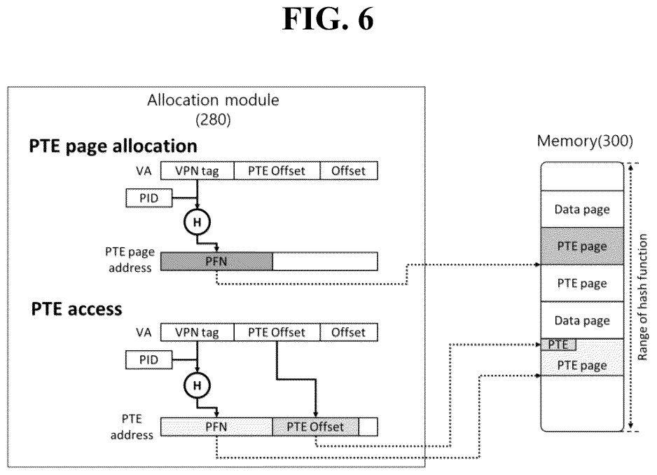

FIGS. 6 to 8 are conceptual diagrams illustrating that the allocation module 280 of the memory management device 100 using the hash-based distributed page table DPT according to an embodiment allocates a page table entry address to generate a distributed page table DPT.

The allocation module 280 may generate a distributed page table DPT for allocating a page table entry page to the entire area of the memory 300 based on the generated page table entry address. In addition, as illustrated in FIG. 6, the allocation module 280 may allocate at least one of a page table entry allocation page and a page table entry access page. In detail, as illustrated in FIG. 6, the allocation module 280 may allocate one page table entry page at the time of page table entry allocation. In addition, the allocation module 280 may allocate an access page to a page table entry after the page table entry page is allocated through a hash function.

The allocation module 280 may scan the frame bitmap of the memory 300 to determine whether the physical frame of the memory 300 corresponding to the physical frame number is empty, and when it is determined that the physical frame is empty, may allocate the physical frame to a page table entry page in the memory 300 corresponding to the physical frame.

Specifically, FIGS. 6 to 8 are PTE allocation processes of the allocation module 280. First, the allocation module 280 checks the frame bitmap to check whether the target physical frame for the hashed PFN is empty. The bitmap indicates whether each physical frame (size 4 KB) is empty or is allocated to store PTE. Each bitmap item includes Free bits and PTE flag bits (Free, PTE). (1, 0) indicates that the frame is empty, and (0, 0) or (0, 1) indicates that the corresponding frame has already been allocated.

If the target frame is empty, the allocation module 280 allocates it as an PTE page for the given VA. The allocation module 280 then uses the PTE offset to place the PTE at a particular location in the page. The allocation module 280 may generate a distributed page table DPT that manages the PTE in the entire area of the memory 300.

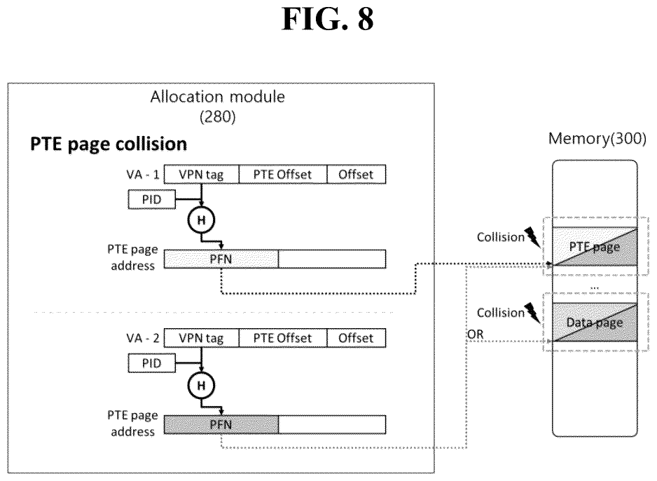

As shown in FIG. 8, if another PTE page or data page already exists in the target frame, the allocation module 280 may generate the distributed page table DPT by applying the collision resolution technique.

The distributed page table generation unit 260 greatly reduces the possibility of hash collision by expanding the range of the hash function by utilizing the entire physical memory 300 space. However, as the use of the memory 300 increases, there is a possibility that the DPT allocates the PTE page to a physical address occupied by another page (PTE page or general data page). This is called an address collision. The address collision resolution technology of the distributed page table generation unit 260 may be a Strided Open Addressing (SOA), a Collision-Aware Virtual Address Allocation (CVA), a Collided Page Dispersion (CPD), and a Fragmentation-Aware PTE Allocation (FAP). The SOA, the CVA, the CPD, and the FAP may be independent and combined to improve the performance of the memory management device 100. The operation of the SOA module 291, the CVA module 292, the CPD module 293, and the FAP module 294 will be described in detail later.

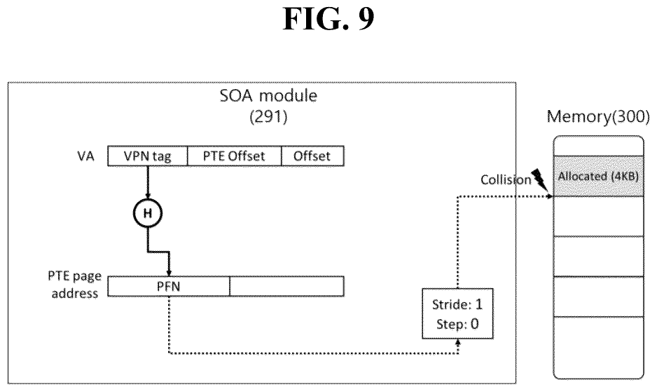

FIGS. 9 to 12 are conceptual diagrams illustrating that the SOA module 291 of the memory management device 100 using the hash-based distributed page table DPT generates the distributed page table DPT through the SOA technique.

When it is determined that the physical frame is not empty, the SOA module 291 may determine a predetermined page stride matching the size of the page in the memory 300 corresponding to the physical frame, and when the page in the memory 300 moved according to the predetermined page stride from the page in the memory 300 corresponding to the physical frame is empty, may allocate the page to the moved page as the page table entry page. When generating the distributed page table DPT, the SOA module 291 may select a predetermined page stride from among a plurality of predetermined page strides.

The SOA module 291 sequentially searches for empty physical frames through a search method at regular strides. The operating system supports multiple page sizes, such as 4 KB (base page), 2 MB (large page), and 1 GB (extra large page). Therefore, the address where the collision has occurred may be located on a basic, large, or extra-large page. In consideration of multiple page size support, the SOA module 291 uses two parameters (strides and steps) and a hash function to generate an PFN sequence that can quickly find an empty physical frame.

For example, when the operating system supports three page sizes of 4 KB (basic page), 2 MB (large page), and 1 GB (extra large page), the SOA module 291 may use three predetermined page strides (1, 512, 256K). The SOA module 291 may use stride 1 when the collided address is located in the default page, and may specify a predetermined page stride among a plurality of predetermined page strides by using strides of 512 and 256K for collisions in the large page and the extra-large page, respectively. The step parameter can reach a design parameter called MAX SOA STEP.

When the PFN calculated by the hash function is already allocated, the SOA module 291 first determines the page size allocated to the corresponding PFN by checking the free bit of the frame bitmap. Then, the SOA module 291 calculates the next PFN to be searched using the appropriate stride and step 1 according to Equation 1 below.

$${PFN}_{PTE} = Hash ( VPN tag ) + Stride \times Step \qquad [ Equation 1 ]$$

Here, PFN_{PTE} denotes a physical frame number for a moved page, Hash( ) denotes a hash function, VPN tag denotes a virtual page number, Stride denotes a predetermined page stride, and Step denotes a step of a moved page for each predetermined page stride.

If the next PFN is already allocated, the SOA module 291 increases the step value by 1 and calculates the PFN again. If the SOA module 291 does not find an empty physical frame until it reaches MAX SOA STEP in the current stride, it uses the next larger stride value. However, the SOA module 291 may fail even after the entire search, and in this case, the distributed page table generation unit 260 may solve the problem through another collision resolution technique.

FIGS. 9 to 12 show how the SOA module 291 resolves address collisions in two scenarios. In the first scenario, a collision occurs if the PFN calculated by the hash function is already assigned to the 4 KB base page. To resolve this collision, the SOA module 291 retrieves an empty frame in the next frame, and in this example, it may find an empty frame in only two steps. Accordingly, two VA parameters (stride and step) may be set to 1 and 2 in the metadata table for the corresponding SOA region, respectively. These parameters are used in the PFN calculation when accessing the VA region.

In the second scenario, the collided physical frame may already be allocated to the large 2 MB page. In this case, it may be difficult for the SOA module 291 to find an empty frame within a step limited to a short stride such as stride 1. In this situation, the SOA module 291 uses the stride of 512 to find an empty frame beyond the 2 MB range. In the example, the SOA module 291 successfully finds the empty frame using the stride 512 and step 1.

The stride-based search method of the SOA module 291 may be easily implemented by checking an empty bit in the frame bitmap. The search function starts from an empty bit of a specific VA indexed with a hash function, and the SOA module 291 sequentially checks the bits until it finds an empty frame within the search range (stride×MAX SOA STEP). If no empty frame is found, the SOA module 291 may continue the search using the larger stride 512 or 256K.

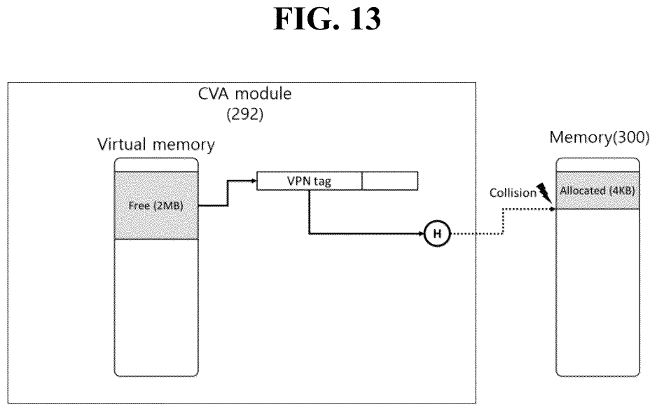

FIGS. 13 to 16 are conceptual diagrams illustrating that the CVA module 292 of the memory management device 100 using the hash-based distributed page table DPT generates the distributed page table DPT through the CVA technique according to an embodiment.

When it is determined that the physical frame is not empty, the CVA module 292 may set a new virtual page number that increases the virtual page number, generate a new physical frame number corresponding to the new virtual page number, and allocate the new page as a page table entry page when the new page in the memory 300 corresponding to the new physical frame number is empty.

Specifically, the SOA module 291 may search for possible physical frames to effectively resolve address collisions, but the range of the search window only operates within the limits defined by the stride and step parameters. Since this parameter is stored in the memory 300 per virtual memory area and loaded during address translation, it may be impractical to use a large number of bits for this parameter due to hardware overhead.

The CVA module 292 may select the non-collision VA to resolve the address collision, instead of selecting the non-collision PFN for the given VA. Fortunately, the operating system has considerable flexibility in selecting a virtual memory area when allocating the memory 300. In addition, the virtual address space is often much larger than the physical memory 300, so that a wide range in which the operating system may allocate a virtual memory area to be used in the memory 300 allocation process may be provided.

The CVA module 292 utilizes the flexibility to select a virtual memory area when allocating the memory 300. Since the allocation module 280 allocates one PTE page for each 2 MB virtual memory area as described above, the CVA module 292 may search for a 2 MB area in which a collision does not occur. FIGS. 13 to 16 illustrate a method of finding a virtual memory area in which the CVA module 292 does not collide. When the memory 300 allocation request occurs, the CVA module 292 identifies an available virtual memory area and calculates the PFN using the VA of the area. As shown in FIGS. 13 to 16, the PFN derived from the VPN tag 1 may cause an address collision that is already in use. As a result, the CVA module 292 recalculates the PFN in another available virtual memory area, and then checks for potential collisions with the PFN. Since the physical frame corresponding to the new PFN is empty, the CVA module 292 allocates the physical frame to store the PTE page of the virtual memory area. Finally, the allocation module 280 may satisfy the memory 300 allocation request by providing the application with the virtual address of the newly allocated area.

As described above, the CVA module 292 searches for an area without collision in units of 2 MB. Accordingly, it may be difficult for the CVA module 292 to find an area without a collision greater than 2 MB. This is due to the requirement that all 2 MB chunks in a large area have no collisions. Due to this constraint, the CVA module 292 limits the memory 300 allocation size to MAX CVA SIZE, which provides an upper limit on the memory 300 size that can be allocated using CVA. In addition, the CVA module 292 limits the maximum number of searches to MAX CVA CNT, so that the memory 300 allocation process does not become a performance bottleneck due to extensive searches to find areas without collisions.

In demand paging, the PFN may be allocated when the allocated VA is accessed, so there is a possibility that the application of the CVA may be limited. This limitation can be mitigated by pre-allocating the PFN for the allocated VA or by resolving collisions in the improperly allocated PFN using other collision resolution techniques (SOA and CPD).

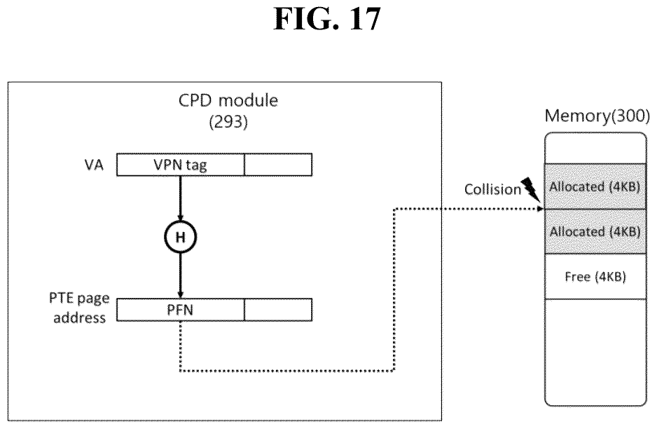

FIGS. 17 to 21 are conceptual diagrams illustrating that the CPD module 293 of the memory management device 100 using the hash-based distributed page table DPT generates the distributed page table DPT through the CPD technique.

When it is determined that the physical frame is not empty, the CPD module 293 may move the data page allocated to the physical frame to an empty page in the memory 300 and allocate the data page to a page table entry page in the memory 300 corresponding to the physical frame. In addition, when moving a data page allocated to a physical frame to an empty page in the memory 300, the CPD module 293 may set the data page as a victim and move the data page to an empty page in the memory 300.

The SOA module 291 and the CVA module 292 may help the DPT to avoid address collisions. Nevertheless, address collisions may still occur when the use of the physical memory 300 increases or when there is not enough collision-free VA area available.

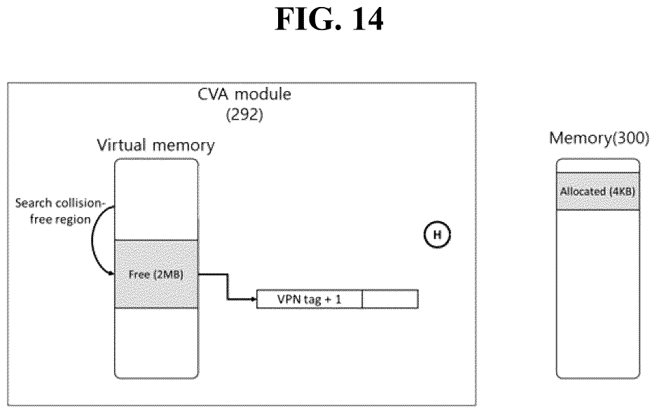

In order to solve this problem, the CPD module 293 may move a data page already allocated to the collided physical frame to a new frame. FIGS. 14 to 22 illustrate a method in which the CPD module 293 resolves an address collision. The CPD module 293 selects a page located in the collided page as a victim. If the target page is a data page, the CPD module 293 moves the target page to an empty frame.

When the page is moved to another physical frame, the CPD module 293 should update the PTE of the target page so that the VA connected to the target page is correctly redirected to the new physical frame. To this end, the CPD module 293 utilizes a reverse map that is frequently used in modern operating systems to efficiently process page swapping, movement, and compression. The reverse map maintains the physical address of the PTE corresponding to each physical frame, so that the physical address of the PTE of the target page may be directly obtained.

The CPD module 293 does not move the PTE page. This is because the page table is designed to have non-mobility characteristics to ensure stability in the modern operating system. In addition, the distributed page table generation unit 260 may not move a specific page displayed as non-mobility by an I/O driver or a kernel component. In order to resolve address collisions for non-mobile or PTE pages, the CPD module 293 cooperates with the SOA module 291 to identify potential damage targets among movable pages. When SOA is used, PFN is calculated through Equation 1, and the CPD module 293 may select an appropriate target from among the candidates that may reach the SOA module 291.

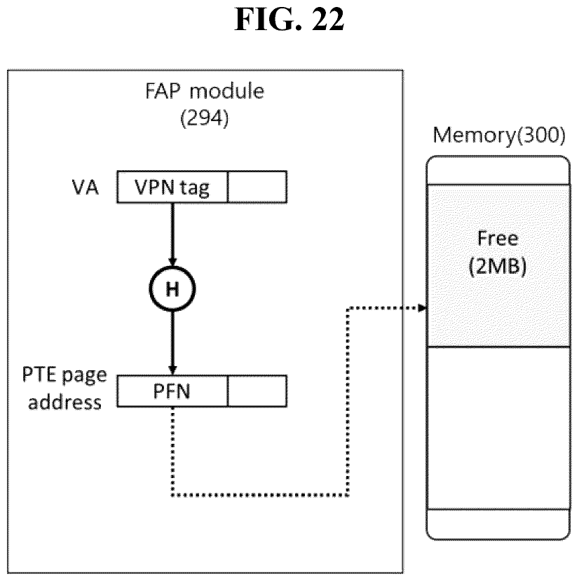

FIGS. 22 to 25 are conceptual diagrams illustrating that the FAP module 294 of the memory management device 100 using the hash-based distributed page table DPT generates the distributed page table DPT through the FAP technique.

The FAP module 294 may scan the frame bitmap of the memory 300 to determine whether the physical frame of the memory 300 corresponding to the physical frame number is included in the fragmentation area, and may allocate the fragmentation area as a page table entry page in the memory 300 corresponding to the physical frame.

External fragmentation occurs when there is sufficient overall free memory 300, but a discontinuous block arrangement prevents the allocation of larger contiguous space. Since the distributed page table generation unit 260 distributes the PTE to the entire physical memory 300, this fragmentation may be further intensified. Since the operating system prevents PTE page movement, it becomes difficult to combine a small free memory 300 block into a large continuous block during memory 300 compression.

To minimize external fragmentation due to PTE allocation, the distributed page table generation unit 260 may perform Fragmentation-Aware PTE Allocation (FAP). The FAP module 294 selects a physical frame within a 2 KB fragmentation area that is already divided into discontinuous 4 MB pages when assigning PTE pages. To this end, the FAP module 294 checks whether the spare 4 KB physical frame selected as the hash function is within the discontinuous 2 MB region using the frame bitmap. If an address collision occurs, the FAP module 294 allocates one of the free physical frames selected by a collision resolution technique, such as SOA, CVA, or CPD.

The distributed page table generation unit 260 may use PTE pooling (PTP) to reduce address collisions by allocating several PTE pages in advance in the physical memory 300. During application initialization, the PTP pre-allocates PTE pages to the continuous virtual memory space of the heap area to generate a reserved area. In this step, in order to prevent unnecessary use of the memory 300, a physical frame is not allocated to each PTE. Therefore, the PFN and the current field of the PTE are set to 0, indicating that a physical frame has not yet been allocated. When there is an allocation request for the memory 300, the distributed page table generation unit 260 dynamically allocates the virtual address space of the reserved area to the application at runtime. Through this, the distributed page table generation unit 260 may efficiently manage the use of the memory 300 and reduce the possibility of address collision.

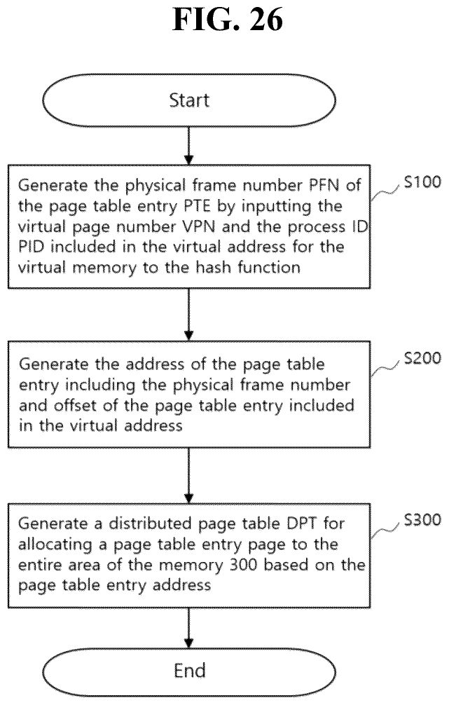

Hereinafter, an embodiment of a memory management method using a hash-based distributed page table DPT will be described with reference to FIG. 26.

FIG. 26 is a flowchart of a memory management method using a hash-based distributed page table (DPT) according to an embodiment.

First, the processor 200 may generate the physical frame number PFN of the page table entry PTE by inputting the virtual page number VPN and the process ID PID included in the virtual address for the virtual memory to the hash function through the address generation module 270 (S100).

Thereafter, the processor 200 may generate the address of the page table entry including the physical frame number and the offset of the page table entry included in the virtual address through the address generation module 270 (S200).

Finally, the processor 200 may generate a distributed page table DPT for allocating a page table entry page to the entire area of the memory 300 based on the page table entry address generated through the allocation module 280 (S300).

It will be understood by those skilled in the art to which the embodiments of the present invention pertain that various modifications can be made without departing from the essential characteristics of the disclosed embodiments. Therefore, the disclosed methods should be considered in a descriptive rather than a limiting sense. The scope of the present invention is defined by the claims rather than the detailed description, and all variations and modifications equivalent thereto should be interpreted as being included within the scope of the present invention.

What is claimed is:

1. A memory management method using a hash-based distributed page table, comprising:
generating a physical frame number (PFN) of a page table entry (PTE) by inputting a process ID (PID) and a virtual page number (VPN) included in a virtual address (VA) for a virtual memory into a hash function;
generating an address of the page table entry including the physical frame number and an offset of the page table entry included in the virtual address; and
generating a distributed page table (DPT) allocating a page table entry page for an entire memory area based on the generated page table entry address.

2. The method of claim 1,
wherein the generating of the distributed page table comprises:
allocating at least one of a page table entry allocation page and a page table entry access page.

3. The method of claim 1,
wherein the generating of the distributed page table comprises:
scanning a frame bitmap of the memory to determine whether a physical frame of the memory corresponding to the physical frame number is empty; and
when it is determined that the physical frame is empty, allocating a page in the memory corresponding to the physical frame as a page table entry page.

4. The method of claim 3,
wherein the generating of the distributed page table comprises:
when it is determined that the physical frame is not empty, determining a predetermined page stride that matches a size of a page in the memory corresponding to the physical frame; and
when a page in the memory that has moved from the page corresponding to the physical frame according to the predetermined page stride is empty, allocating the moved page as a page table entry page.

5. The method of claim 4,
wherein the generating of the distributed page table comprises:
selecting the predetermined page stride from among a plurality of predetermined page strides.

6. The method of claim 4,
wherein when the distributed page table is generated, the determining of the moved page is performed by using the following equation.
$${PFN}_{PTE} = Hash ( VPN tag ) + Stride \times Step$$
(wherein, PFN_{PTE} denotes “physical frame number for the moved page”, Hash( ) denotes “hash function”, VPN tag denotes “virtual page number”, Stride denotes “predetermined page stride”, and Step denotes “a step of the moved page for each predetermined page stride”)

7. The method of claim 3,
wherein the generating of the distributed page table comprises:
when it is determined that the physical frame is not empty, setting a new virtual page number obtained by increasing the virtual page number;
generating a new physical frame number corresponding to the new virtual page number; and
when a new page in the memory corresponding to the new physical frame number is empty, allocating the new page as a page table entry page.

8. The method of claim 3,
wherein the generating of the distributed page table comprises:
when it is determined that the physical frame is not empty, moving a data page allocated to the physical frame to an empty page within the memory; and
allocating a page in the memory corresponding to the physical frame as a page table entry page.

9. The method of claim 8,
wherein the generating of the distributed page table comprises:
when moving a data page allocated to the physical frame to an empty page within the memory, setting the data page as a victim and moving the data page to the empty page within the memory.

10. The method of claim 3,
wherein the generating of the distributed page table comprises:
scanning a frame bitmap of the memory to determine whether a physical frame of the memory corresponding to the physical frame number is included in a fragmented region, and
allocating a page in the memory corresponding to the physical frame as a page table entry page.

11. A memory management device using a hash-based distributed page table, comprising:
a memory having a physical memory space; and
a processor configured to generate a physical frame number (PFN) of a page table entry (PTE) by inputting a process ID (PID) and a virtual page number (VPN) included in a virtual address (VA) for a virtual memory into a hash function, generate an address of the page table entry including the physical frame number and an offset of the page table entry included in the virtual address and generate a distributed page table (DPT) allocating a page table entry page for an entire memory area based on the generated page table entry address.

12. The device of claim 11,
wherein the processor is configured to allocate at least one of a page table entry allocation page and a page table entry access page.

13. The device of claim 11,
wherein the processor is configured to scan a frame bitmap of the memory to determine whether a physical frame of the memory corresponding to the physical frame number is empty and, when it is determined that the physical frame is empty, allocate a page in the memory corresponding to the physical frame as a page table entry page.

14. The device of claim 13,
wherein the processor is configured to, when it is determined that the physical frame is not empty, determine a predetermined page stride that matches a size of a page in the memory corresponding to the physical frame and, when a page in the memory that has moved from the page corresponding to the physical frame according to the predetermined page stride is empty, allocate the moved page as a page table entry page.

15. The device of claim 14,
wherein the processor is configured to select the predetermined page stride from among a plurality of predetermined page strides.

16. The device of claim 14,
wherein, when the processor generates the distributed page table, determining the moved page is determined through the following equation.
PFN_{PTE}=Hash(VPN tag)+Stride×Step
(wherein, PFN_{PTE} denotes “physical frame number for the moved page”, Hash( ) denotes “hash function”, VPN tag denotes “virtual page number”, Stride denotes “predetermined page stride”, and Step denotes “a step of the moved page for each predetermined page stride”)

17. The device of claim 13,
wherein the processor is configured to, when it is determined that the physical frame is not empty, set a new virtual page number obtained by increasing the virtual page number, generate a new physical frame number corresponding to the new virtual page number and, when a new page in the memory corresponding to the new physical frame number is empty, allocate the new page as a page table entry page.

18. The device of claim 11,
wherein the processor is configured to, when it is determined that the physical frame is not empty, move a data page allocated to the physical frame to an empty page within the memory and allocate a page in the memory corresponding to the physical frame as a page table entry page.

19. The device of claim 11,
wherein the processor is configured to, when moving a data page allocated to the physical frame to an empty page within the memory, set the data page as an victim and move the data page to the empty page within the memory.

20. The device of claim 11,
wherein the processor is configured to scan a frame bitmap of the memory to determine whether a physical frame of the memory corresponding to the physical frame number is included in a fragmented region, and allocate a page in the memory corresponding to the physical frame as a page table entry page.
